(19) United States
(12) Patent Application Publication
(10) Pub. No.: US 2026/0040360 A1
(43) Pub. Date: Feb. 5, 2026

(54) ADAPTIVE CARRIER SELECTION FOR RANDOM ACCESS CHANNEL PROCEDURES USING MACHINE LEARNING

(71) Applicant: QUALCOMM Incorporated, San Diego, CA (US)

(72) Inventors: Ambarish TRIPATHI, San Diego, CA (US); Anuj KHANNA, Hyderabad (IN); Zhibin DANG, San Diego, CA (US)

(21) Appl. No.: 18/794,970

(22) Filed: Aug. 5, 2024

(51) Int. Cl. H04W 74/0833; H04B 17/318

(52) U.S. Cl. CPC H04W 74/0833; H04B 17/328

(57) ABSTRACT

Methods, systems, and devices for wireless communications are described. In some examples, a UE may select a carrier from a plurality of configured carriers for a random access channel (RACH) procedure on a cell using a machine learning model. The UE may monitor parameters during each RACH attempt of the RACH procedure to determine a channel dataset associated with the cell. Based on a channel dataset for a current RACH procedure, the ML model may predict a likelihood of successfully performing a RACH procedure for each carrier. The UE 115 may select a carrier based on the prediction and may perform the RACH procedure. In some examples, the UE may switch carriers after failing a quantity of RACH attempts of the RACH procedure. Additionally, or alternatively, the UE may declare an early radio link failure based on failing the quantity of RACH attempts and the prediction.

### TECHNICAL FIELD

The following relates to wireless communications, including adaptive carrier selection for random access channel procedures using machine learning.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving configuration information indicating for the UE to evaluate a set of multiple parameters at each random access channel (RACH) attempt, monitoring one or more carriers of a set of multiple different carriers, based on the configuration information, to obtain a channel dataset including values for the set of multiple parameters associated with a first RACH attempt, selecting a first carrier from the set of multiple different carriers in accordance with a prediction associated with the first carrier based on the channel dataset, where the prediction indicates a likelihood of successfully performing a RACH procedure using the first carrier, and communicating one or more messages of a RACH procedure using the first carrier.

A UE for wireless communications is described. The UE may include one or more memories storing processor executable code, and one or more processors coupled with (e.g., operatively, communicatively, functionally, electronically, or electrically) the one or more memories. The one or more processors may individually or collectively be operable to execute the code (e.g., directly, indirectly, after pre-processing, without pre-processing) to cause the UE to receive configuration information indicating for the UE to evaluate a set of multiple parameters at each RACH attempt, monitor one or more carriers of a set of multiple different carriers, based on the configuration information, to obtain a channel dataset including values for the set of multiple parameters associated with a first RACH attempt, select a first carrier from the set of multiple different carriers in accordance with a prediction associated with the first carrier based on the channel dataset, where the prediction indicates a likelihood of successfully performing a RACH procedure using the first carrier, and communicate one or more messages of a RACH procedure using the first carrier.

Another UE for wireless communications is described. The UE may include means for receiving configuration information indicating for the UE to evaluate a set of multiple parameters at each RACH attempt, means for monitoring one or more carriers of a set of multiple different carriers, based on the configuration information, to obtain a channel dataset including values for the set of multiple parameters associated with a first RACH attempt, means for selecting a first carrier from the set of multiple different carriers in accordance with a prediction associated with the first carrier based on the channel dataset, where the prediction indicates a likelihood of successfully performing a RACH procedure using the first carrier, and means for communicating one or more messages of a RACH procedure using the first carrier.

A non-transitory computer-readable medium storing code for wireless communications is described. The code may include instructions executable by one or more processors (e.g., directly, indirectly, after pre-processing, without pre-processing) to receive configuration information indicating for the UE to evaluate a set of multiple parameters at each RACH attempt, monitor one or more carriers of a set of multiple different carriers, based on the configuration information, to obtain a channel dataset including values for the set of multiple parameters associated with a first RACH attempt, select a first carrier from the set of multiple different carriers in accordance with a prediction associated with the first carrier based on the channel dataset, where the prediction indicates a likelihood of successfully performing a RACH procedure using the first carrier, and communicate one or more messages of a RACH procedure using the first carrier.

In some examples of the method, UEs, and non-transitory computer-readable medium described herein, selecting the first carrier may include operations, features, means, or instructions for selecting the first carrier based on a quantity of failed RACH attempts associated with a second carrier of the set of multiple different carriers satisfying a threshold.

Some examples of the method, UEs, and non-transitory computer-readable medium described herein may further include operations, features, means, or instructions for declaring a radio link failure, terminating the RACH procedure, or both, based on a quantity of failed RACH attempts associated with a first carrier satisfying a first threshold and a second quantity of RACH attempts associated with a second carrier satisfying a second threshold.

Some examples of the method, UEs, and non-transitory computer-readable medium described herein may further include operations, features, means, or instructions for declaring a radio link failure, terminating the RACH procedure, or both, based on a quantity of failed RACH attempts for the first carrier satisfying an early termination threshold.

Some examples of the method, UEs, and non-transitory computer-readable medium described herein may further include operations, features, means, or instructions for monitoring the one or more carriers of the set of multiple different carriers, based on the configuration information, to obtain an updated channel dataset including updated values for the set of multiple parameters associated with a second RACH attempt that occurs subsequent to the first RACH attempt, selecting the first carrier or a second carrier from the set of multiple different carriers in accordance with a second prediction associated with the first carrier or the second carrier based on the updated channel dataset, where the second prediction indicates a likelihood of successfully performing a RACH procedure using the first carrier or the second carrier, and communicating one or more messages of a second RACH procedure using the first carrier or the second carrier.

In some examples of the method, UEs, and non-transitory computer-readable medium described herein, selecting the first carrier may include operations, features, means, or instructions for selecting the first carrier in accordance with the prediction based on a quantity of channel datasets satisfying a first threshold, a quantity of failed RACH attempts satisfying a second threshold, a duration satisfying a third threshold, or any combination thereof.

In some examples of the method, UEs, and non-transitory computer-readable medium described herein, where, for the first RACH attempt, a second carrier of the set of multiple different carriers may be associated with a higher RSRP than the first carrier and where the first carrier may be selected for the first RACH attempt based on the prediction associated with the first carrier and the second carrier being associated with the higher RSRP than the first carrier.

In some examples of the method, UEs, and non-transitory computer-readable medium described herein, the set of multiple parameters include a downlink reference signal reserve power associated with the first carrier, a signal-to-noise ratio, a pathloss, a RACH configuration, a quantity of RACH attempts associated with the RACH procedure, location coordinates, a selected synchronization signal block, a purpose associated with the RACH procedure, a physical RACH (PRACH) transmit power, an uplink block error rate (BLER), a downlink BLER, a transmission power of the UE, a maximum transmit power level (MTPL), or any combination thereof.

In some examples of the method, UEs, and non-transitory computer-readable medium described herein, the first carrier may be a supplementary uplink and a second carrier of the set of multiple different carriers may be a normal uplink.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports adaptive carrier selection for random access channel procedures using machine learning in accordance with one or more aspects of the present disclosure.

FIG. 2 shows an example of a wireless communications system that supports adaptive carrier selection for random access channel procedures using machine learning in accordance with one or more aspects of the present disclosure.

FIG. 3 shows an example of flowcharts that support adaptive carrier selection for random access channel procedures using machine learning in accordance with one or more aspects of the present disclosure.

FIG. 4 shows an example of a flowchart that supports adaptive carrier selection for random access channel procedures using machine learning in accordance with one or more aspects of the present disclosure.

FIG. 5 shows an example of a flowchart that supports adaptive carrier selection for random access channel procedures using machine learning in accordance with one or more aspects of the present disclosure.

FIG. 6 shows an example of a process flow that supports adaptive carrier selection for random access channel procedures using machine learning in accordance with one or more aspects of the present disclosure.

FIGS. 7 and 8 show block diagrams of devices that support adaptive carrier selection for random access channel procedures using machine learning in accordance with one or more aspects of the present disclosure.

FIG. 9 shows a block diagram of a communications manager that supports adaptive carrier selection for random access channel procedures using machine learning in accordance with one or more aspects of the present disclosure.

FIG. 10 shows a diagram of a system including a device that supports adaptive carrier selection for random access channel procedures using machine learning in accordance with one or more aspects of the present disclosure.

FIG. 11 shows a flowchart illustrating methods that support adaptive carrier selection for random access channel procedures using machine learning in accordance with one or more aspects of the present disclosure.

### DETAILED DESCRIPTION

In some wireless communications systems, a user equipment (UE) may communicate with a network entity via uplink. In some examples, the UE may communicate with the network entity via a normal uplink (NUL) (e.g., a primary uplink), a supplementary uplink (SUL) (e.g., a secondary uplink), or both. In such examples, the UE may select the NUL or the SUL in accordance with a reference signal reserve power (RSRP) associated with the NUL and the SUL. However, the UE may only evaluate the RSRP at the beginning of a random access channel (RACH) procedure. That is, the UE may not evaluate the RSRP at each RACH attempt of a RACH procedure, which may lead to inaccurate uplink carrier selection for subsequent RACH attempts based on out-of-date information. For example, the UE may select a RACH carrier that fails due to a change in wireless channel conditions on a subsequent RACH attempt that varies from wireless channel conditions at an initial RACH attempt.

Various aspects of the present disclosure are related to adaptive carrier selection for RACH procedures using machine learning. A UE may select a carrier (e.g., NUL, SUL) to use for a RACH procedure based on a prediction generated by a machine learning (ML) model. The UE may monitor channel conditions or other parameters during a RACH attempt (e.g., of the RACH procedure) to determine a channel dataset associated with a cell. The UE may provide the channel dataset to the ML model to train the ML model. In some examples, the UE may provide a channel dataset to the ML model for each RACH procedure performed by the UE. The ML model may determine a plurality of predictions and may indicate a probability of a successful RACH procedure using a carrier (e.g., the NUL, the SUL). The UE may select the indicated carrier based on the prediction and may perform the RACH procedure. In some examples, the UE may switch carriers after performing and failing a quantity of RACH attempts of the RACH procedure. Additionally, or alternatively, the UE may declare an early radio link failure based on failing the quantity of RACH attempts and the prediction.

Aspects of the disclosure are initially described in the context of wireless communications systems. Aspects of the disclosure are additionally described with reference to flowcharts and process flows. Aspects of the disclosure are further illustrated by and described with reference to apparatus diagrams, system diagrams, and flowcharts that relate to adaptive carrier selection for RACH procedures using machine learning.

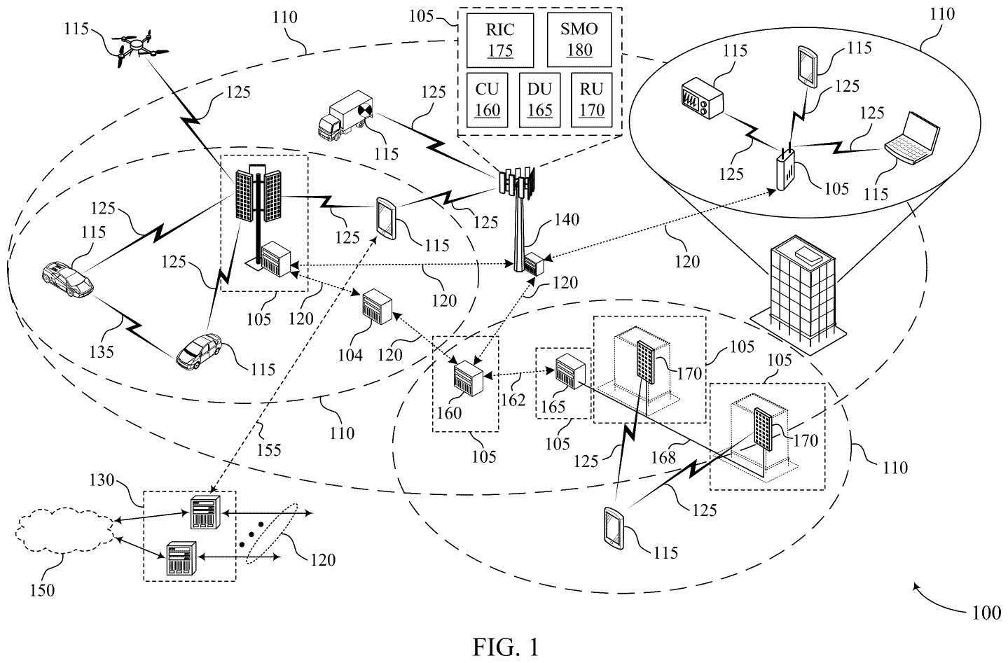

FIG. 1 shows an example of a wireless communications system 100 that supports adaptive carrier selection for RACH procedures using machine learning in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples, a UE 115 may perform carrier selection for a RACH procedure in accordance with an ML model. The UE 115 may monitor channel conditions or other parameters during each RACH attempt of the RACH procedure to determine a channel dataset associated with a cell. The UE 115 may provide the channel dataset to the ML model to train the ML model. In some examples, the UE 115 may provide a channel dataset to the ML model for each RACH procedure performed by the UE 115. Additionally, the UE 115 may update each channel dataset for each RACH attempt of each RACH procedure. The ML model may determine a plurality of predictions and may indicate a probability of a successful RACH procedure using one of the carriers (e.g., the NUL, the SUL). The UE 115 may select a carrier based on the prediction and may perform the RACH procedure. In some examples, the UE 115 may switch carriers after performing and failing a quantity of RACH attempts of the RACH procedure. Additionally, or alternatively, the UE 115 may declare an early radio link failure based on failing the quantity of RACH attempts and the prediction.

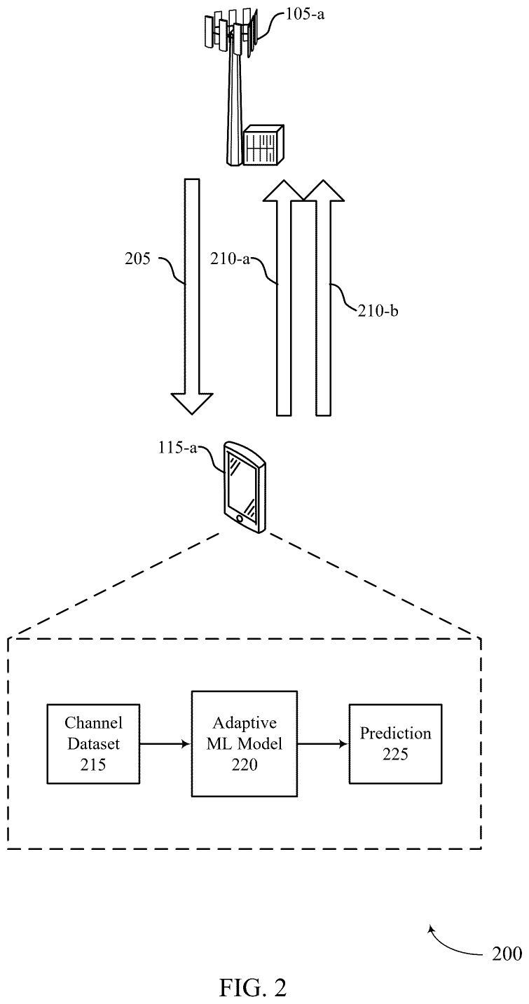

FIG. 2 shows an example of a wireless communications system 200 that supports adaptive carrier selection for RACH procedures using machine learning in accordance with one or more aspects of the present disclosure. The wireless communications system 200 may include a UE 115-a in communications with a network entity 105-a, which may be examples of corresponding devices described herein, including with reference to FIG. 1. The network entity 105-a may provide coverage via a cell and may be associated with a PCID X. The UE 115-a may communicate with the network entity 105-a via one or more communication links, including downlink 205 and uplinks 210. In some examples, the network entity 105-a may configure the UE 115-a with a NUL 210-a (e.g., a primary uplink 210) and a SUL 210-b (e.g., a secondary uplink 210). In some examples, the downlink 205 may correspond to the NUL 210-a.

The UE 115-a may perform a RACH procedure to establish communications with the network entity 105-a. For example, the UE 115-a may select a carrier (e.g., the NUL 210-a, the SUL 210-b) for performing the RACH procedure with the network entity 105-a. In some examples, the UE 115-a may select the SUL 210-b to increase cell coverage in the uplink direction where an uplink transmit power is not as strong.

In some implementations, the UE 115-a may select the carrier in accordance with a RSRP. For example, the network entity 105-a may configure the UE 115-a with an RSRP threshold for the SUL 210-b, and the UE 115-a may select either the NUL 210-a or the SUL 210-b for the RACH procedure in accordance with the RSRP threshold for the SUL 210-b. In some cases, the SUL 210-b may be FDD and the NUL 210-a may be TDD. In such cases, the UE 115-a may perform carrier selection based on a downlink RSRP associated with the NUL 210-a. For example, the UE 115-a may select the NUL 210-a if a downlink RSRP associated with the NUL 210-a is greater than the RSRP threshold for the SUL 210-b. In such implementations, the UE 115-a may perform carrier selection at the beginning of the RACH procedure.

However, in such implementations, channel conditions may change after the RACH procedure has been initiated. For example, the wireless channel may be dynamic, or the UE 115-a may be experiencing mobility. Accordingly, a carrier selected at the beginning of the RACH procedure may become unsuitable after the RACH procedure has been initiated, which may cause RACH failure and may cause the UE 115-a to declare radio link failure (RLF). In such cases, the UE 115-a may introduce delays associated with regaining uplink synchronization due to the RACH failure or due to an increased quantity of RACH attempts.

In some examples, the UE 115-a may enhance carrier selection between the NUL 210-a and the SUL 210-b by implementing ML model analysis based on one or more cell-level characteristics (e.g., a channel data set). For example, the UE 115-a may select a carrier from a set of two or more carriers (e.g., selected between the NUL 210-a and the SUL 210-b) in accordance with an ML-based prediction during a RACH procedure to adapt to dynamic channel conditions during the RACH procedure. In some examples, the UE 115-a may be configured with an adaptive ML model 220. The adaptive ML model 220 may be an on-device component of the UE 115-a. In such examples, the adaptive ML model 220 may output a prediction 225 for the NUL 210-a and a prediction 225 for the SUL 210-b. The prediction 225 may indicate a likelihood of successfully performing a RACH procedure using a carrier (e.g., the NUL 210-a or the SUL 210-b). For example, the prediction 226 may indicate a probability of RACH success using the NUL 210-a or a probability of RACH success using the SUL 210-b.

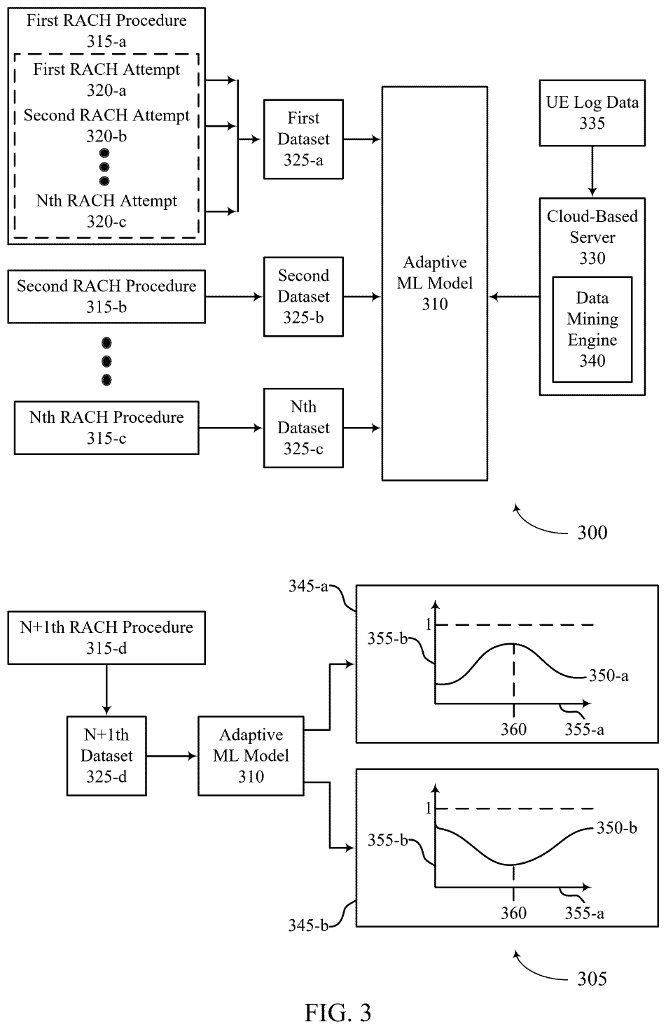

In some examples, to output the prediction 225, the adaptive ML model 220 may output a probability distribution function of a quantity of channel datasets 215 and a probability of performing a successful RACH procedure using either the NUL 210-a or the SUL 210-b on cell X. In some examples, a vertical axis (e.g., a Y axis) of the probability distribution function may represent a probability of successful RACH on a carrier (e.g., the NUL 210-a or the SUL 210-b), and a horizontal axis (e.g., an X axis) of the probability distribution function may represent a quantity of datasets associated with the cell X. The probability distribution function is described in more detail herein with reference to FIG. 3.

The UE 115-a may initiate a RACH procedure on a carrier (e.g., the NUL, the SUL) with the network entity 105-a. During the RACH procedure, the UE 115-a may monitor the carrier to collect (e.g., measure, record, determine) one or more RACH parameters for the carrier that are associated with the cell (e.g., associated with a particular PCID). For example, the UE 115-a may determine a channel dataset 215 (e.g., a UE channel dataset 215) that maps to the cell X associated with the network entity 105-a. The channel dataset 215 may include one or more RACH-related statistics (e.g., parameters) associated with the cell X, including a downlink RSRP associated with the NUL 210-a, a signal-to-noise ratio, a pathloss, a RACH configuration, a quantity of RACH attempts associated with the RACH procedure, one or more location coordinates, a selected synchronization signal block (SSB), a purpose associated with the RACH procedure, a physical RACH (PRACH) transmit power, an uplink block error rate (BLER), a downlink BLER, a transmission power of the UE, a maximum transmit power level (MTPL) associated with the UE, or any combination thereof.

The UE 115-a may determine a channel dataset 215 for each RACH attempt on the cell X. For example, the UE 115-a may perform a number N of RACH attempts using a carrier and may monitor the carrier for each RACH attempt to determine a corresponding number N of channel datasets 215 associated with the cell X (e.g., N is a positive integer). The UE 115-a may use the N channel datasets 215 to train the adaptive ML model 220. For example, the UE 115-a may provide the adaptive ML model 220 with the N channel datasets 215. After the N channel datasets 215 satisfies a threshold quantity, the UE 115-a may use the adaptive ML model 220 to predict a probability that a RACH procedure using the NUL 210-a or the SUL 210-b will be successful. For example, the UE 115-a may leverage a prediction 225 of the adaptive ML model 220 when re-attempting a RACH procedure on the cell X. In some examples, the N channel datasets 215 satisfying the threshold quantity may indicate to the UE 115-a that there is sufficient information at the adaptive ML model 220 to make an accurate prediction 225 of which carrier to use for a RACH procedure.

In some examples, channel datasets 215 provided to the adaptive ML model 220 may be associated with a weight. A channel dataset 215 may be weighted lower relative to other channel datasets 215 based on a lifetime associated with the channel dataset 215. For example, the UE 115-a may assign a lower weight to a channel dataset 215 based on a quantity M of time (e.g., days, weeks, months) since the channel dataset 215 was collected. In some cases, a channel dataset 215 with a lower weight may indicate for the UE 115-a to re-learn (e.g., re-collect) information associated with the channel dataset 215 based on a latest configuration from the network entity and updated RACH statistics for the cell X associated with the channel dataset 215.

Additionally, the adaptive ML model 220 may be trained using cloud-based server data. For example, a cloud-based server may collect and analyze RACH-related statistics from other UEs 115 (not shown) in a same area or a similar area (e.g., a geographical coverage area) as the UE 115-a. In some examples, the UE 115-a may be configured to automatically upload log data comprising the RACH-related statistics to the cloud-based server. For example, the UE 115-a may provide the cloud-based server with a RACH carrier, a RACH result, some or all of a channel dataset 215, or any combination thereof.

Accordingly, the UE 115-a may select a carrier for a RACH procedure on a cell X based on a downlink RSRP associated with the NUL 210-a, as well as additional criteria including previous history of RACH success or failure. For example, the UE 115-a may determine that a downlink RSRP associated with the NUL 210-a satisfies (e.g., is less than) a threshold RSRP for the SUL 210-b. However, the adaptive ML model 220 may indicate that previous RACH procedures on the cell X using the NUL 210-a failed and may indicate that there is a high probability that subsequent RACH procedures using the NUL 210-a will fail based on conditions associated with the cell X. Accordingly, the UE 115-a may select the SUL 210-b for the RACH procedure. Similarly, the UE 115-a may determine that a downlink RSRP associated with the NUL 210-a fails to satisfy (e.g., is greater than) the threshold RSRP for the SUL 210-b. However, the adaptive ML model 220 may indicate that there is a high probability that subsequent RACH procedures using the SUL 210-b will fail based on conditions associated with the cell X, and the UE 115-a may select the NUL 210-a for the RACH procedure.

Alternatively, or additionally, the UE 115-a may initiate an early exit from a RACH procedure based on the prediction 225 from the adaptive ML model 220. For example, if the adaptive ML model 220 indicates that a probability of a successful RACH procedure on a cell X using a carrier is low (e.g., is below a configured threshold probability), the UE 115-a may determine to exit the RACH procedure on the cell X and may initiate another RACH procedure on a different cell (e.g., a UE 115-a is on a cell edge and traveling in the direction of a different cell). The UE 115-a may initiate the early exit to reduce latency associated with resynchronizing with the network entity 105-a by avoiding unnecessary RACH attempts on a sub-optimal cell.

FIG. 3 shows an example of a first flowchart 300 and a second flowchart 305 that support adaptive carrier selection for RACH procedures using machine learning in accordance with one or more aspects of the present disclosure. The first flowchart 300 and the second flowchart 305 may illustrate example processes performed by a UE (not shown) for predicting a carrier for performing a RACH procedure. In some examples, the UE may be configured to communicate with a network entity (not shown) via a plurality of carriers including a NUL and a SUL, which may be examples of corresponding devices and features described herein, including with reference to FIG. 2. Additionally, the UE may include an adaptive ML model 310. In some cases, the adaptive ML model 310 may be on-device; that is, may be integrated with the UE.

The first flowchart 300 may illustrate an example process for training an adaptive ML model 310 of a UE. In some examples, the UE may perform a quantity N of RACH procedures 315 on a cell with PCID X (e.g., a cell X). For example, the UE may perform a first RACH procedure 315-a and a second RACH procedure 315-b, up to an Nth RACH procedure 315-c (e.g., where N is a positive integer). Each RACH procedure may include a quantity of RACH attempts 320. For example, when the UE initiates the first RACH procedure 315-a, the UE may perform a quantity N of RACH attempts 320, including a first RACH attempt 320-a and a second RACH attempt 320-b, up to an Nth RACH attempt 320-c. In some cases, the UE may receive configuration information from the network entity indicating to evaluate one or more parameters for each RACH attempt 320.

Further, each RACH procedure 315 may be associated with a dataset 325 (e.g., a channel dataset). In some examples, the UE may monitor a carrier for the RACH procedure 315 to determine one or more values for the one or more parameters in order to determine the corresponding dataset 325. For example, the first RACH procedure 315-a may be associated with a first dataset 325-a, the second RACH procedure 315-b may be associated with a second dataset 325-b, and the Nth RACH procedure 315-c may be associated with an Nth dataset 325-c. In some cases, the UE may update the dataset 325 based on the configuration information from the network entity indicating to evaluate the one or more parameters for each RACH attempt 320. The UE may use the datasets 325 to train the adaptive ML model 310. For example, the UE may provide the adaptive ML model 310 with the datasets 325 as inputs to the adaptive ML model 310.

In some examples, the UE may update a dataset 325 for each RACH attempt 320 of a corresponding RACH procedure 315. For example, the UE may update the first dataset 325-a for the first RACH attempt 320-a and for the second RACH attempt 320-b, up to the Nth RACH attempt 320-c. Updating the datasets 325 for each RACH attempt 320 may allow the UE to adapt to dynamic wireless channel conditions, such as during a period of high-mobility at the UE.

Additionally, the adaptive ML model 310 may be trained using information from a cloud-based server 330. In some cases, UEs may upload UE log data 335 to the cloud-based server 330. Additionally, or alternatively, the cloud-based server 330 may implement a data mining engine 340 to acquire the UE log data. In some examples, the cloud-based server 330 may collect and analyze statistic information from multiple UEs in a similar area (e.g., geographical area). Statistic information may include a RACH carrier, a RACH result, a RSRP, a SNR, a transmit power, an MTPL, or any combination thereof, as well as other RACH-related statistics as described herein with reference to FIG. 2. The UE may download processed data from the cloud-based server 330 to train the adaptive ML model 310.

The second flowchart 305 may illustrate an example process for predicting a carrier using the adaptive ML model 310. In some examples, after performing the N RACH procedures 315 on the cell X and training the adaptive ML model 310, the UE may attempt a subsequent RACH procedure 315 on the cell X. For example, the UE may initiate an N+1th RACH procedure 315-d and may determine a corresponding N+1th dataset 325-d. The UE may provide the N+1th dataset 325-d to the adaptive ML model 310, which may generate a prediction 345 associated with each carrier configured to the UE (e.g., the NUL and the SUL). The predictions 345 may indicate a likelihood of successfully performing a RACH procedure 315 using the NUL or the SUL (e.g., a probability that the associated carrier passes RACH). For example, the adaptive ML model may output a probability distribution function 350, where a horizontal axis 355-a may represent the total quantity of datasets 325 provided to the adaptive ML model 310 and where a vertical axis 355-b may represent the probability that the associated carrier passes RACH for a latest dataset 360.

For example, the adaptive ML model 310 may generate a first prediction 345-a associated with the SUL and may generate a second prediction 345-b associated with the NUL. The first prediction 345-a may include a first probability distribution function 350-a associated with the SUL, and the second prediction 345-b may include a second probability distribution function 350-b associated with the NUL. The adaptive ML model 310 may generate the predictions 345 based on the N+1th dataset 325-d, as well as the previous datasets 325 provided to the adaptive ML model 310 during training (e.g., the first dataset 325-a, the second dataset 325-b, the Nth dataset 325-c).

The UE may select a carrier from the plurality of configured carriers based on the predictions 345. For example, the first prediction 345-a associated with the SUL may indicate a higher probability of RACH success than the second prediction 345-b associated with the NUL. Accordingly, in this example, the UE may select the SUL for performing a next RACH attempt 320 of the N+1th RACH procedure 315-d.

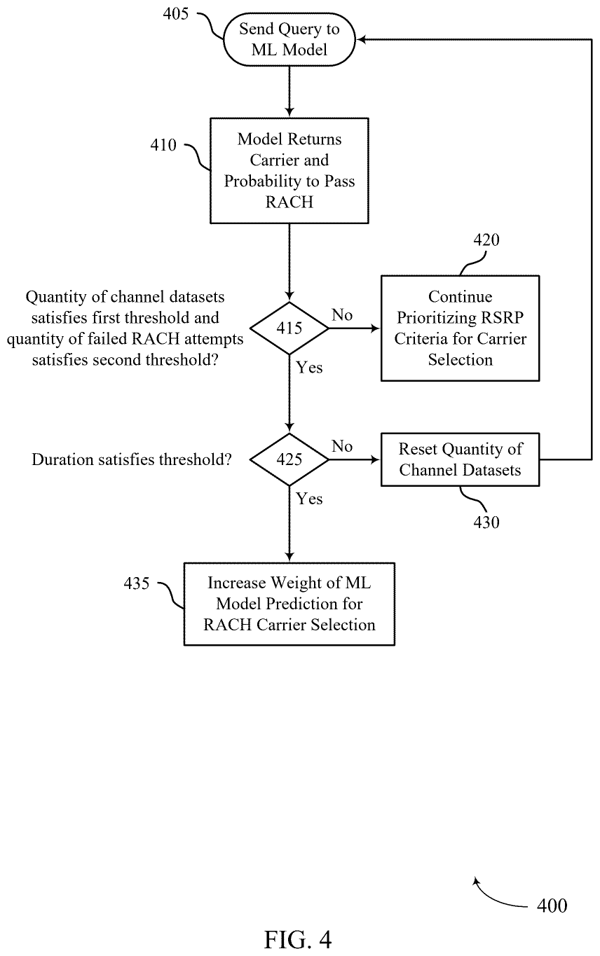

FIG. 4 shows an example of a flowchart 400 that supports adaptive carrier selection for RACH procedures using machine learning in accordance with one or more aspects of the present disclosure. The flowchart 400 may illustrate an example process performed by a UE (not shown) for selecting a carrier for performing a RACH procedure. In some examples, the UE may be configured to communicate with a network entity (not shown) via a plurality of carriers including a NUL and a SUL, which may be examples of corresponding devices and features described herein, including with reference to FIG. 2. Additionally, the UE may include an adaptive ML model. In some cases, the adaptive ML model may be on-device; that is, may be integrated with the UE.

At 405, the UE may send a query to the adaptive ML model. In some examples, the UE may send the query based on providing the adaptive ML model with one or more channel datasets associated with one or more respective RACH procedures on a cell performed by the UE.

At 410, the adaptive ML model may return (e.g., output) information associated with the plurality of carriers, including an indication of a carrier and a prediction indicating a likelihood of successfully performing a RACH procedure using the carrier (e.g., a probability that the carrier passes RACH). The adaptive ML model may output the information based on receiving the query from the UE.

At 415, the UE may determine whether a quantity of channel datasets satisfies a first threshold and whether a quantity of failed RACH attempts satisfies a second threshold. For example, the UE may determine whether a quantity of channel datasets D is greater than a threshold quantity of datasets Dₜₕᵣₑₛₕ (e.g., whether D>Dₜₕᵣₑₛₕ) and may determine whether a quantity of failed RACH attempts Nᵣₛᵣₚ is greater than a threshold number of failed RACH attempts X (e.g., whether Nᵣₛᵣₚ>X). In some examples, carrier selection for Nᵣₛᵣₚ and X may be based on an RSRP criteria. If, at 415 the UE determines that either the quantity of channel datasets fails to satisfy the first threshold (e.g., that D<Dₜₕᵣₑₛₕ) or that the quantity of failed RACH attempts fails to satisfy the second threshold (e.g., that Nᵣₛᵣₚ<X), then at 420 the UE may determine to continue prioritizing the RSRP criteria for carrier selection. For example, the UE may assign a higher weight to the RSRP criteria when selecting a carrier for performing RACH.

The quantity of channel datasets D may include a total quantity of channel datasets collected by the UE, and the first threshold Dₜₕᵣₑₛₕ may represent a quantity of datasets that should be met to consider the output of the adaptive ML model. That is, the first threshold Dₜₕᵣₑₛₕ may indicate whether the adaptive ML model has received enough data to be sufficiently trained. The quantity of failed RACH attempts Nᵣₛᵣₚ may be a quantity of previous RACH attempts where carrier selection (e.g., between the NUL and the SUL) was determined based on RSRP criteria. In some cases, the UE may select the NUL based on a downlink RSRP for the NUL satisfying (e.g., being less than) a threshold RSRP for the SUL, as described with reference to FIG. 2. The second threshold X may represent a quantity of previous RACH attempts where carrier selection was determined based on at least one RSRP criterion.

Otherwise, if at 415 the UE determines that both quantity of channel datasets satisfies the first threshold and that the quantity of failed RACH attempts satisfies the second threshold (e.g., that both D>Dₜₕᵣₑₛₕ and Nᵣₛᵣₚ>X), then at 425 the UE may determine whether a duration satisfies a threshold. For example, the UE may determine whether a difference between a current time T_{curr} and a reference time T_{ref} is less than a threshold time Tₜₕᵣₑₛₕ (e.g., whether T_{curr}−T_{ref}<Tₜₕᵣₑₛₕ). In some examples, the reference time T_{ref} may represent a time when a most recent learning (e.g., training) of the adaptive ML model was completed. The threshold time Tₜₕᵣₑₛₕ may represent a time duration for re-learning (e.g., re-training) of the adaptive ML model.

If, at 425 the UE determines that the duration fails to satisfy the threshold (e.g., that T_{curr}−T_{ref}>Tₜₕᵣₑₛₕ), then at 430 the UE may reset the quantity of channel datasets D to zero and return to 405. Otherwise, if the UE determines that the duration satisfies the threshold (e.g., that T_{curr}−T_{ref}<Tₜₕᵣₑₛₕ), then at 435 the UE may determine to prioritize the output of the ML model for carrier selection. For example, the UE may assign a higher weight to predictions generated by the ML model relative to other criteria, such as the RSRP threshold.

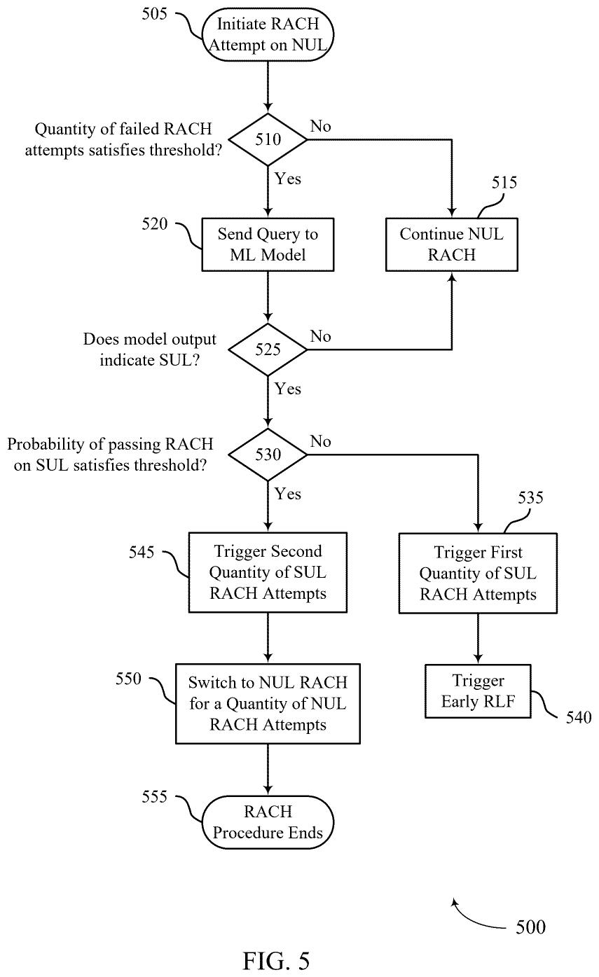

FIG. 5 shows an example of a flowchart 500 that supports adaptive carrier selection for RACH procedures using machine learning in accordance with one or more aspects of the present disclosure. The flowchart 500 may illustrate an example process performed by a UE (not shown) for switching between a first carrier and a second carrier during a RACH procedure. In some examples, the UE may be configured to communicate with a network entity (not shown) via a plurality of carriers including a NUL and a SUL, which may be examples of corresponding devices and features described herein, including with reference to FIG. 2. Additionally, the UE may include an adaptive ML model. In some cases, the adaptive ML model may be on-device; that is, may be integrated with the UE.

At 505, the UE may initiate a RACH attempt on a cell on NUL. In some examples, the UE may initiate an Nth RACH attempt of a plurality of RACH attempts on NUL. For example, the UE may have previously performed N−1 RACH attempts on the cell on NUL.

At 510, the UE may determine whether a quantity of failed RACH attempts satisfies a threshold. For example, the UE may determine whether N is greater than a threshold quantity of failed RACH attempts Z. In some examples, the quantity of failed RACH attempts may include some or all of the plurality of RACH attempts on NUL. If, at 510 the UE determines that the quantity of failed RACH attempts fails to satisfy the threshold (e.g., that N<Z), then at 515 the UE may continue performing RACH attempts on the cell using NUL.

Otherwise, if the UE determines that the quantity of failed RACH attempts satisfies the threshold (e.g., that N>Z), then at 520 the UE may send a query to the adaptive ML model. In some examples, the UE may send the query based on providing the adaptive ML model with one or more channel datasets corresponding to one or more respective RACH procedures on the cell on NUL previously performed by the UE. In some examples, the adaptive ML model may output information based on receiving the query from the UE.

At 525, the UE may determine whether an output of the adaptive ML model indicates the SUL. For example, the adaptive ML model may return (e.g., output) information on the plurality of carriers, including an indication of a carrier and a probability that such a carrier passes RACH. If, at 525 the UE determines that the model output does not indicate the SUL, then the UE may return to 515 and continue performing RACH attempts on the cell using NUL. For example, the model output may indicate the NUL, and the UE may continue using the NUL accordingly.

Otherwise, if at 525 the UE determines that the model output indicates the SUL, then at 530 the UE may determine whether a probability of passing RACH on the SUL satisfies a threshold. For example, the UE may determine whether a probability P(SUL) is greater than a threshold Pₜₕᵣₑₛₕ (e.g., whether P(SUL)>Pₜₕᵣₑₛₕ). In some examples, the output of the adaptive ML model may indicate the probability P(SUL). The threshold Pₜₕᵣₑₛₕ may represent a minimum probability of RACH success on SUL.

If, at 530 the UE determines that the probability of passing RACH using the SUL fails to satisfy the threshold (e.g., that P(SUL)<Pₜₕᵣₑₛₕ), then at 535 the UE may be triggered to perform a first quantity of RACH attempts R on the SUL. In some examples, the first quantity of RACH attempts R may represent a reduced quantity of RACH attempts relative to a second quantity of RACH attempts M.

At 540, the UE may trigger (e.g., declare) an early RLF. In some examples, the UE may trigger the early RLF based on the first quantity of RACH attempts R on the SUL satisfying a first threshold, where the first threshold may represent a quantity of failed RACH attempts on the SUL. For example, the UE may trigger the early RLF if R is greater than the first threshold. In some examples, the first threshold may represent an early exit threshold.

Otherwise, if at 530 the UE determines that the probability of passing RACH using the SUL satisfies the threshold (e.g., that P(SUL)>Pₜₕᵣₑₛₕ), then at 545, the UE may be triggered to perform a second quantity of RACH attempts M on the SUL. In some examples, the second quantity of RACH attempts M may be based on the output of the adaptive ML model. Additionally, the second quantity of RACH attempts M on the SUL may be greater than the first quantity of RACH attempts R on the SUL.

At 550, the UE may switch carriers from the SUL to the NUL and may perform a quantity of RACH attempts on the NUL. In some examples, the UE may switch carriers based on the second quantity of RACH attempts M on the SUL satisfying a second threshold, where the second threshold may represent a quantity of failed RACH attempts on the SUL. For example, the UE may switch carriers if M is greater than the second threshold. In some examples, the second threshold may be greater than the first threshold. The quantity of RACH attempts on the NUL may be based on a difference between a maximum total of transmitted RACH Msg1 Y and the sum of the N RACH attempts on NUL and the second quantity of RACH attempts M. For example, the UE may perform a quantity Y−(N+M) of RACH attempts on the NUL.

At 555, the RACH procedure may end. In some examples, the RACH procedure may end after a total quantity of RACH attempts satisfies (e.g., is greater than or equal to) a threshold. In some examples, the threshold may represent a maximum quantity of total RACH attempts that the UE can perform. The RACH procedure may end as a success or as a failure based on whether the UE successfully performs RACH within the quantity of RACH attempts on the NUL.

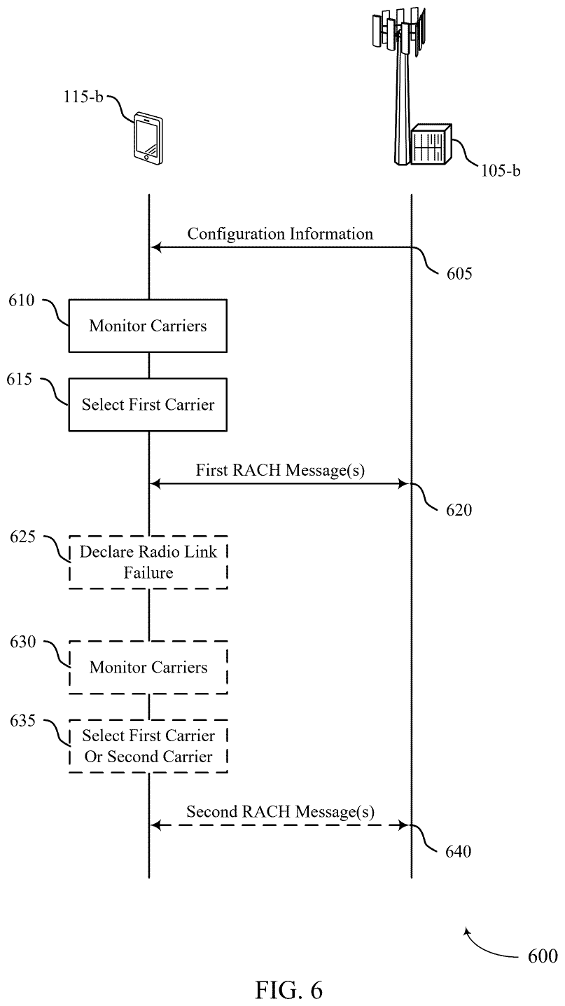

FIG. 6 shows an example of a process flow 600 that supports adaptive carrier selection for RACH procedures using machine learning in accordance with one or more aspects of the present disclosure. The process flow 600 may implement or be implemented by aspects of the wireless communications system 100 and the wireless communications system 200, as described with reference to FIGS. 1 and 2. For example, the process flow 600 illustrates actions performed by a UE 115-b and a network entity 105-b, which may be examples of corresponding devices described herein, including with reference to FIGS. 1-2. In the following description of the process flow 600, the operations between the UE 115-b and the network entity 105-b may be performed in a different order than the example shown, or the operations between the UE 115-b and the network entity 105-b may be performed in different orders at different times. Some operations may also be omitted from the process flow 600, and other operations may be added to the process flow 600.

At 605, the UE 115-b may receive configuration information indicating for the UE 115-b to evaluate a plurality of parameters at each RACH attempt. In some examples, the configuration information may indicate for the UE 115-b to evaluate the plurality of parameters at each RACH attempt of a plurality of RACH attempts to be performed by the UE 115-b. The plurality of parameters may include a downlink RSRP associated with a first carrier, an SNR, a pathloss, a RACH configuration, a quantity of RACH attempts associated with the RACH procedure, location coordinates, a selected SSB, a purpose associated with the RACH procedure, a PRACH transmit power, an uplink BLER, a downlink BLER, a transmission power of the UE, a MTPL, or any combination thereof.

At 610, the UE 115-b may monitor one or more carriers of a plurality of different carriers, based on the configuration information, to obtain a channel dataset including values for the plurality of parameters associated with a first RACH attempt. In some examples, the UE 115-b may be configured with a first carrier and a second carrier. In such examples, the first carrier may be a SUL and a second carrier of the plurality of different carriers may be a NUL.

At 615, the UE 115-b may select the first carrier from the plurality of different carriers in accordance with a prediction associated with the first carrier based on the channel dataset. In some examples, the prediction may indicate a likelihood of successfully performing a RACH procedure using the first carrier. In some examples, the UE 115-b may select the first carrier based on a quantity of failed RACH attempts associated with the second carrier of the plurality of different carriers satisfying a threshold. Additionally, or alternatively, the UE 115-b may select the first carrier in accordance with the prediction based on a quantity of channel datasets satisfying the first threshold, a quantity of failed RACH attempts satisfying a second threshold, a duration satisfying a third threshold, or any combination thereof. In some cases, for the first RACH attempt, the second carrier of the plurality of different carriers may be associated with a higher RSRP than the first carrier. In some other cases, the UE 115-b may select the first carrier for the first RACH attempt based on the prediction associated with the first carrier and the second carrier being associated with the higher RSRP than the first carrier.

At 620, the UE 115-b may communicate one or more messages of a RACH procedure using the first carrier. In some examples, the one or more messages of the RACH procedure may include a RACH Msg1, a RACH Msg2, a RACH Msg3, a RACH Msg4, a RACH MsgA, a RACH MsgB, or any combination thereof.

At 625, the UE 115-b may declare a radio link failure, may terminate the RACH procedure, or both, based on a quantity of failed RACH attempts associated with the first carrier satisfying a first threshold and a second quantity of RACH attempts associated with the second carrier satisfying a second threshold. Alternatively, the UE 115-b may declare a radio link failure, may terminate the RACH procedure, or both, based on a quantity of failed RACH attempts for the first carrier satisfying an early termination threshold.

At 630, the UE 115-b may monitor the one or more carriers of the plurality of different carriers, based on the configuration information, to obtain an updated channel dataset comprising updated values for the plurality of parameters associated with a second RACH attempt that occurs subsequent to the first RACH attempt.

At 635, the UE 115-b may select the first carrier or the second carrier from the plurality of different carriers in accordance with a second prediction associated with the first carrier or the second carrier based on the updated channel dataset. In some examples, the second prediction may indicate a likelihood of successfully performing a second RACH procedure using the first carrier or the second carrier.

At 640, the UE 115-b may communicate one or more messages of the second RACH procedure using the first carrier or the second carrier. In some examples, the one or more messages of the RACH procedure may include a RACH Msg1, a RACH Msg2, a RACH Msg3, a RACH Msg4, a RACH MsgA, a RACH MsgB, or any combination thereof.

In conventional techniques or methods, a UE may use one carrier for all RACH attempts of a RACH procedure and may continue to attempt RACH on a cell even after channel conditions for the cell have changed. In an example, the UE may be configured with a first cell, a second cell, and a RSRP threshold for the SUL rsrp-ThresholdSSB-SUL. At the beginning of a RACH procedure, the UE may determine that a NUL RSRP for the first cell is greater than the RSRP threshold (e.g., that RSRP>rsrp-ThresholdSSB-SUL) and may select the NUL for a RACH procedure on the first cell. In some cases, after one or more RACH attempts on the first cell on NUL, one or more channel conditions of the first cell (e.g., RSRP, pathloss, transmission power) may change such that the NUL RSRP for the first cell is no longer greater than the RSRP threshold (e.g., RSRP<rsrp-ThresholdSSB-SUL). Continued attempts to perform RACH with the first cell on the NUL may fail, which may cause increased latency for synchronizing with a network entity and may incur additional power draw for each failed RACH attempt.

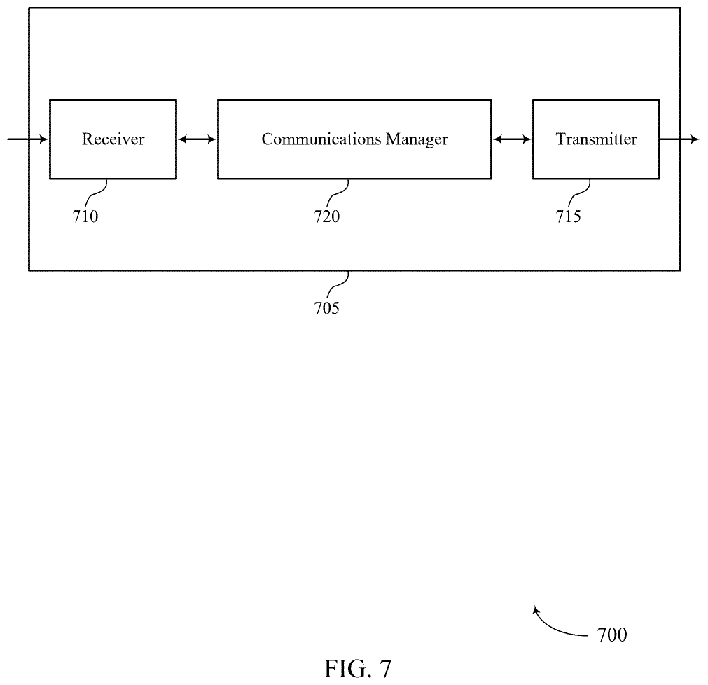

By implementing the techniques as described herein for dynamic carrier selection, the UE may support methods for switching between carriers during a RACH procedure. For example, after a quantity of failed RACH attempts N−1 with the first cell on NUL, the UE may select the SUL for a quantity of subsequent RACH attempts M with the first cell. Additionally, or alternatively, by implementing the techniques as described herein for dynamic carrier selection, the UE may support methods for declaring an early RLF during a RACH procedure. For example, after quantity of failed RACH attempts N−1 with the first cell on NUL, the UE may select the SUL for a quantity of subsequent RACH attempts R with the first cell, where R is less than M (e.g., R<M). If the subsequent RACH attempts R on SUL fail, the UE may trigger early RLF for the first cell. The UE may initiate a RACH procedure with the second cell after the early RLF. Accordingly, the UE may improve latency associated with network entity synchronization and may save power by reducing a quantity of RACH attempts performed by the UE. FIG. 7 shows a block diagram 700 of a device 705 that supports adaptive carrier selection for RACH procedures using machine learning in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to adaptive carrier selection for RACH procedures using machine learning). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to adaptive carrier selection for RACH procedures using machine learning). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of adaptive carrier selection for RACH procedures using machine learning as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), a graphics processing unit (GPU), a neural processing unit (NPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, a GPU, a NPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving configuration information indicating for the UE to evaluate a set of multiple parameters at each RACH attempt. The communications manager 720 is capable of, configured to, or operable to support a means for monitoring one or more carriers of a set of multiple different carriers, based on the configuration information, to obtain a channel dataset including values for the set of multiple parameters associated with a first RACH attempt. The communications manager 720 is capable of, configured to, or operable to support a means for selecting a first carrier from the set of multiple different carriers in accordance with a prediction associated with the first carrier based on the channel dataset, where the prediction indicates a likelihood of successfully performing a RACH procedure using the first carrier. The communications manager 720 is capable of, configured to, or operable to support a means for communicating one or more messages of a RACH procedure using the first carrier.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced power consumption and improved coordination between devices.

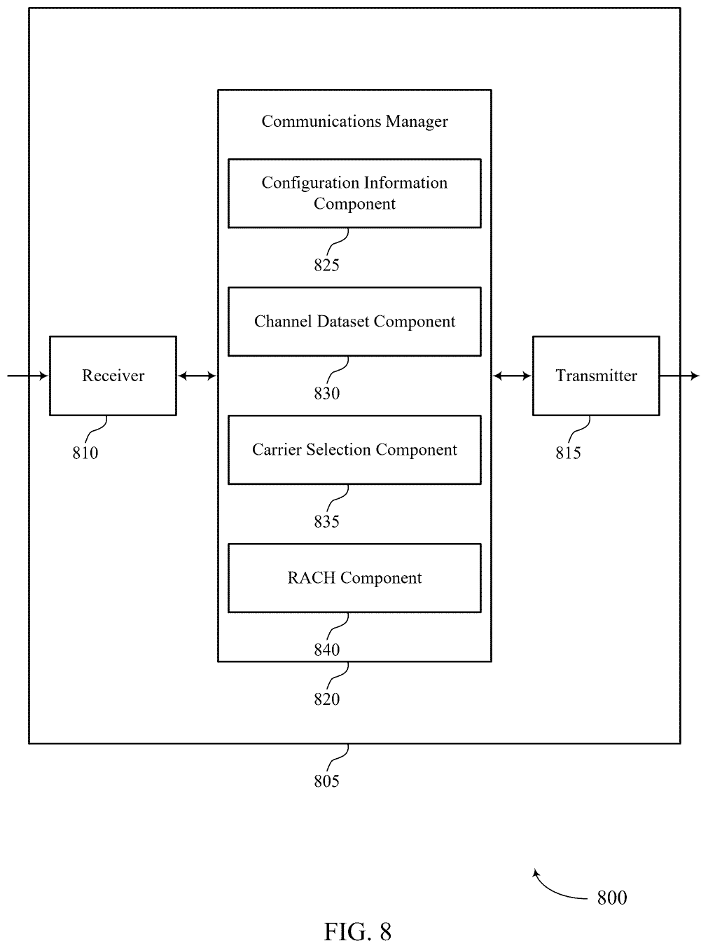

FIG. 8 shows a block diagram 800 of a device 805 that supports adaptive carrier selection for RACH procedures using machine learning in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to adaptive carrier selection for RACH procedures using machine learning). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to adaptive carrier selection for RACH procedures using machine learning). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of adaptive carrier selection for RACH procedures using machine learning as described herein. For example, the communications manager 820 may include a configuration information component 825, a channel dataset component 830, a carrier selection component 835, a RACH component 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The configuration information component 825 is capable of, configured to, or operable to support a means for receiving configuration information indicating for the UE to evaluate a set of multiple parameters at each RACH attempt. The channel dataset component 830 is capable of, configured to, or operable to support a means for monitoring one or more carriers of a set of multiple different carriers, based on the configuration information, to obtain a channel dataset including values for the set of multiple parameters associated with a first RACH attempt. The carrier selection component 835 is capable of, configured to, or operable to support a means for selecting a first carrier from the set of multiple different carriers in accordance with a prediction associated with the first carrier based on the channel dataset, where the prediction indicates a likelihood of successfully performing a RACH procedure using the first carrier. The RACH component 840 is capable of, configured to, or operable to support a means for communicating one or more messages of a RACH procedure using the first carrier.

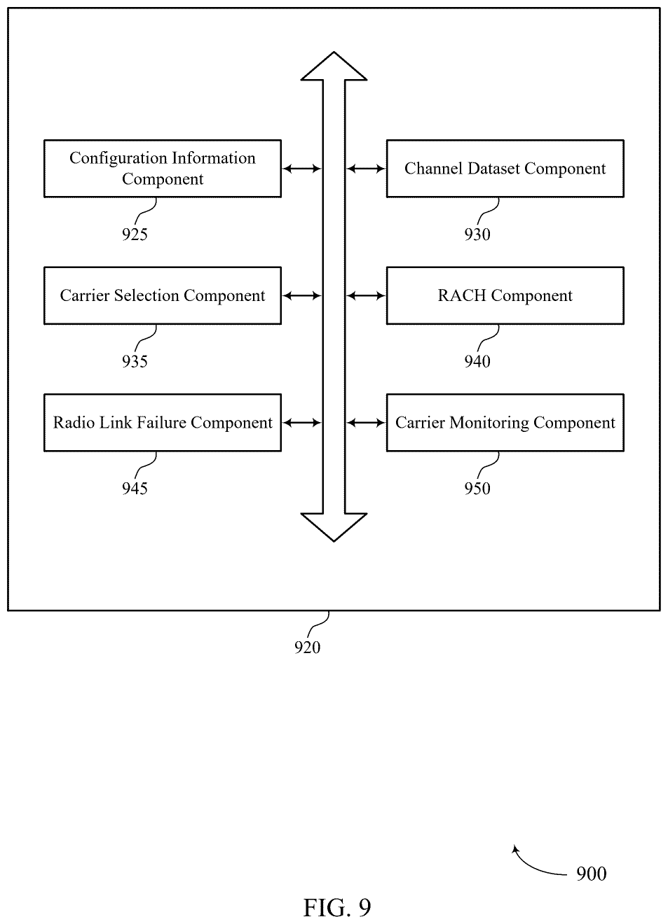

FIG. 9 shows a block diagram 900 of a communications manager 920 that supports adaptive carrier selection for RACH procedures using machine learning in accordance with one or more aspects of the present disclosure. The communications manager 920 may be an example of aspects of a communications manager 720, a communications manager 820, or both, as described herein. The communications manager 920, or various components thereof, may be an example of means for performing various aspects of adaptive carrier selection for RACH procedures using machine learning as described herein. For example, the communications manager 920 may include a configuration information component 925, a channel dataset component 930, a carrier selection component 935, a RACH component 940, a radio link failure component 945, a carrier monitoring component 950, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The configuration information component 925 is capable of, configured to, or operable to support a means for receiving configuration information indicating for the UE to evaluate a set of multiple parameters at each RACH attempt. The channel dataset component 930 is capable of, configured to, or operable to support a means for monitoring one or more carriers of a set of multiple different carriers, based on the configuration information, to obtain a channel dataset including values for the set of multiple parameters associated with a first RACH attempt. The carrier selection component 935 is capable of, configured to, or operable to support a means for selecting a first carrier from the set of multiple different carriers in accordance with a prediction associated with the first carrier based on the channel dataset, where the prediction indicates a likelihood of successfully performing a RACH procedure using the first carrier. The RACH component 940 is capable of, configured to, or operable to support a means for communicating one or more messages of a RACH procedure using the first carrier.

In some examples, to support selecting the first carrier, the carrier selection component 935 is capable of, configured to, or operable to support a means for selecting the first carrier based on a quantity of failed RACH attempts associated with a second carrier of the set of multiple different carriers satisfying a threshold.

In some examples, the radio link failure component 945 is capable of, configured to, or operable to support a means for declaring a radio link failure, terminating the RACH procedure, or both, based on a quantity of failed RACH attempts associated with a first carrier satisfying a first threshold and a second quantity of RACH attempts associated with a second carrier satisfying a second threshold.

In some examples, the radio link failure component 945 is capable of, configured to, or operable to support a means for declaring a radio link failure, terminating the RACH procedure, or both, based on a quantity of failed RACH attempts for the first carrier satisfying an early termination threshold.

In some examples, the carrier monitoring component 950 is capable of, configured to, or operable to support a means for monitoring the one or more carriers of the set of multiple different carriers, based on the configuration information, to obtain an updated channel dataset including updated values for the set of multiple parameters associated with a second RACH attempt that occurs subsequent to the first RACH attempt. In some examples, the carrier selection component 935 is capable of, configured to, or operable to support a means for selecting the first carrier or a second carrier from the set of multiple different carriers in accordance with a second prediction associated with the first carrier or the second carrier based on the updated channel dataset, where the second prediction indicates a likelihood of successfully performing a RACH procedure using the first carrier or the second carrier. In some examples, the RACH component 940 is capable of, configured to, or operable to support a means for communicating one or more messages of a second RACH procedure using the first carrier or the second carrier.

In some examples, to support selecting the first carrier, the carrier selection component 935 is capable of, configured to, or operable to support a means for selecting the first carrier in accordance with the prediction based on a quantity of channel datasets satisfying a first threshold, a quantity of failed RACH attempts satisfying a second threshold, a duration satisfying a third threshold, or any combination thereof.

In some examples, where, for the first RACH attempt, a second carrier of the set of multiple different carriers is associated with a higher RSRP than the first carrier. In some examples, where the first carrier is selected for the first RACH attempt based on the prediction associated with the first carrier and the second carrier being associated with the higher RSRP than the first carrier.

In some examples, the set of multiple parameters include a downlink reference signal reserve power associated with the first carrier, a signal-to-noise ratio, a pathloss, a RACH configuration, a quantity of RACH attempts associated with the RACH procedure, location coordinates, a selected synchronization signal block, a purpose associated with the RACH procedure, a PRACH transmit power, an uplink BLER, a downlink BLER, a transmission power of the UE, a MTPL, or any combination thereof.

In some examples, the first carrier is a SUL and a second carrier of the set of multiple different carriers is a NUL.

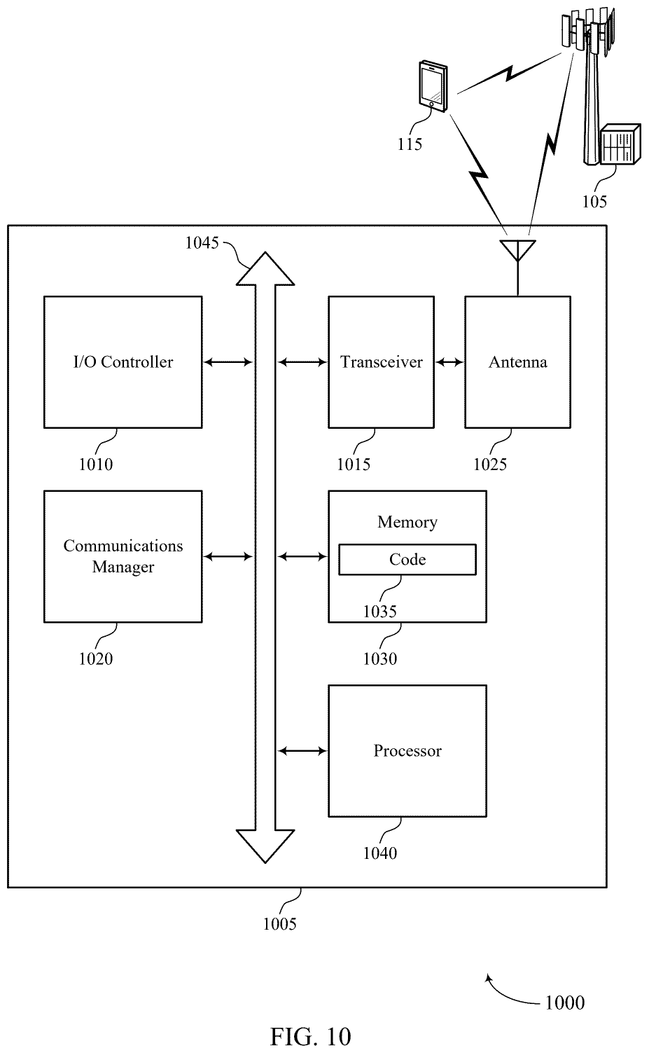

FIG. 10 shows a diagram of a system 1000 including a device 1005 that supports adaptive carrier selection for RACH procedures using machine learning in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more GPUs, one or more NPUs (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting adaptive carrier selection for RACH procedures using machine learning). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving configuration information indicating for the UE to evaluate a set of multiple parameters at each RACH attempt. The communications manager 1020 is capable of, configured to, or operable to support a means for monitoring one or more carriers of a set of multiple different carriers, based on the configuration information, to obtain a channel dataset including values for the set of multiple parameters associated with a first RACH attempt. The communications manager 1020 is capable of, configured to, or operable to support a means for selecting a first carrier from the set of multiple different carriers in accordance with a prediction associated with the first carrier based on the channel dataset, where the prediction indicates a likelihood of successfully performing a RACH procedure using the first carrier. The communications manager 1020 is capable of, configured to, or operable to support a means for communicating one or more messages of a RACH procedure using the first carrier.

By including or configuring the communications manager 1020 in accordance with examples as described herein, the device 1005 may support techniques for reduced latency and improved user experience related to reduced processing and improved coordination between devices.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of adaptive carrier selection for RACH procedures using machine learning as described herein, or the at least one processor 1040 and the at least one memory 1030 may be otherwise configured to, individually or collectively, perform or support such operations.

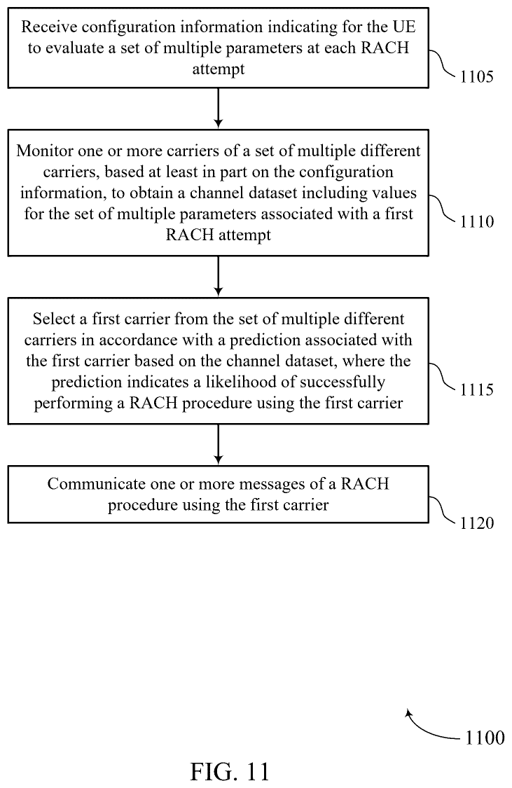

FIG. 11 shows a flowchart illustrating a method 1100 that supports adaptive carrier selection for RACH procedures using machine learning in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1105, the method may include receiving configuration information indicating for the UE to evaluate a set of multiple parameters at each RACH attempt. The operations of 1105 may be performed in accordance with examples as disclosed herein. In some examples, aspects of the operations of 1105 may be performed by a configuration information component 925 as described with reference to FIG. 9.

At 1110, the method may include monitoring one or more carriers of a set of multiple different carriers, based at least in part on the configuration information, to obtain a channel dataset including values for the set of multiple parameters associated with a first RACH attempt. The operations of 1110 may be performed in accordance with examples as disclosed herein. In some examples, aspects of the operations of 1110 may be performed by a channel dataset component 930 as described with reference to FIG. 9.

At 1115, the method may include selecting a first carrier from the set of multiple different carriers in accordance with a prediction associated with the first carrier based at least in part on the channel dataset, where the prediction indicates a likelihood of successfully performing a RACH procedure using the first carrier. The operations of 1115 may be performed in accordance with examples as disclosed herein. In some examples, aspects of the operations of 1115 may be performed by a carrier selection component 935 as described with reference to FIG. 9.

At 1120, the method may include communicating one or more messages of a RACH procedure using the first carrier. The operations of 1120 may be performed in accordance with examples as disclosed herein. In some examples, aspects of the operations of 1120 may be performed by a RACH component 940 as described with reference to FIG. 9.

The following provides an overview of aspects of the present disclosure:
Aspect 1: A method for wireless communications at a UE, comprising: receiving configuration information indicating for the UE to evaluate a plurality of parameters at each RACH attempt; monitoring one or more carriers of a plurality of different carriers, based at least in part on the configuration information, to obtain a channel dataset comprising values for the plurality of parameters associated with a first RACH attempt; selecting a first carrier from the plurality of different carriers in accordance with a prediction associated with the first carrier based at least in part on the channel dataset, wherein the prediction indicates a likelihood of successfully performing a RACH procedure using the first carrier; and communicating one or more messages of a RACH procedure using the first carrier.
Aspect 2: The method of aspect 1, wherein selecting the first carrier further comprises: selecting the first carrier based at least in part on a quantity of failed RACH attempts associated with a second carrier of the plurality of different carriers satisfying a threshold.
Aspect 3: The method of any of aspects 1 through 2, further comprising: declaring a RLF, terminating the RACH procedure, or both, based at least in part on a quantity of failed RACH attempts associated with a first carrier satisfying a first threshold and a second quantity of RACH attempts associated with a second carrier satisfying a second threshold.
Aspect 4: The method of any of aspects 1 through 3, further comprising: declaring a RLF, terminating the RACH procedure, or both, based at least in part on a quantity of failed RACH attempts for the first carrier satisfying an early termination threshold.
Aspect 5: The method of any of aspects 1 through 4, further comprising: monitoring the one or more carriers of the plurality of different carriers, based at least in part on the configuration information, to obtain an updated channel dataset comprising updated values for the plurality of parameters associated with a second RACH attempt that occurs subsequent to the first RACH attempt; selecting the first carrier or a second carrier from the plurality of different carriers in accordance with a second prediction associated with the first carrier or the second carrier based at least in part on the updated channel dataset, wherein the second prediction indicates a likelihood of successfully performing a RACH procedure using the first carrier or the second carrier; and communicating one or more messages of a second RACH procedure using the first carrier or the second carrier.
Aspect 6: The method of any of aspects 1 through 5, wherein selecting the first carrier further comprises: selecting the first carrier in accordance with the prediction based at least in part on a quantity of channel datasets satisfying a first threshold, a quantity of failed RACH attempts satisfying a second threshold, a duration satisfying a third threshold, or any combination thereof.
Aspect 7: The method of any of aspects 1 through 6, wherein, for the first RACH attempt, a second carrier of the plurality of different carriers is associated with a higher RSRP than the first carrier, and wherein the first carrier is selected for the first RACH attempt based at least in part on the prediction associated with the first carrier and the second carrier being associated with the higher RSRP than the first carrier.
Aspect 8: The method of any of aspects 1 through 7, wherein the plurality of parameters comprise a downlink reference signal reserve power associated with the first carrier, a signal-to-noise ratio, a pathloss, a RACH configuration, a quantity of RACH attempts associated with the RACH procedure, location coordinates, a selected synchronization signal block, a purpose associated with the RACH procedure, a PRACH transmit power, an uplink BLER, a downlink BLER, a transmission power of the UE, a MTPL, or any combination thereof.
Aspect 9: The method of any of aspects 1 through 8, wherein the first carrier is a supplementary uplink and a second carrier of the plurality of different carriers is a normal uplink.
Aspect 10: A UE for wireless communications, comprising one or more memories storing processor-executable code, and one or more processors coupled with (e.g., operatively, communicatively, functionally, electronically, or electrically) the one or more memories and individually or collectively operable to execute the code (e.g., directly, indirectly, after pre-processing, without pre-processing) to cause the UE to perform a method of any of aspects 1 through 9.
Aspect 11: A UE for wireless communications, comprising at least one means for performing a method of any of aspects 1 through 9.
Aspect 12: A non-transitory computer-readable medium storing code for wireless communications, the code comprising instructions executable by one or more processors (e.g., directly, indirectly, after pre-processing, without pre-processing) to perform a method of any of aspects 1 through 9.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, a NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive configuration information indicating for the UE to evaluate a plurality of parameters at each random access channel (RACH) attempt;
monitor one or more carriers of a plurality of different carriers, based at least in part on the configuration information, to obtain a channel dataset comprising values for the plurality of parameters associated with a first RACH attempt;
select a first carrier from the plurality of different carriers in accordance with a prediction associated with the first carrier based at least in part on the channel dataset, wherein the prediction indicates a likelihood of successfully performing a RACH procedure using the first carrier; and
communicate one or more messages of a RACH procedure using the first carrier.

2. The UE of claim 1, wherein, to select the first carrier, the one or more processors are individually or collectively further operable to execute the code to cause the UE to:
select the first carrier based at least in part on a quantity of failed RACH attempts associated with a second carrier of the plurality of different carriers satisfying a threshold.

3. The UE of claim 1, wherein the one or more processors are individually or collectively further operable to execute the code to cause the UE to:
declare a radio link failure, terminate the RACH procedure, or both, based at least in part on a quantity of failed RACH attempts associated with a first carrier satisfying a first threshold and a second quantity of RACH attempts associated with a second carrier satisfying a second threshold.

4. The UE of claim 1, wherein the one or more processors are individually or collectively further operable to execute the code to cause the UE to:
declare a radio link failure, terminating the RACH procedure, or both, based at least in part on a quantity of failed RACH attempts for the first carrier satisfying an early termination threshold.

5. The UE of claim 1, wherein the one or more processors are individually or collectively further operable to execute the code to cause the UE to:
monitor the one or more carriers of the plurality of different carriers, based at least in part on the configuration information, to obtain an updated channel dataset comprising updated values for the plurality of parameters associated with a second RACH attempt that occurs subsequent to the first RACH attempt;
select the first carrier or a second carrier from the plurality of different carriers in accordance with a second prediction associated with the first carrier or the second carrier based at least in part on the updated channel dataset, wherein the second prediction indicates a likelihood of successfully performing a RACH procedure using the first carrier or the second carrier; and
communicate one or more messages of a second RACH procedure using the first carrier or the second carrier.

6. The UE of claim 1, wherein, to select the first carrier, the one or more processors are individually or collectively further operable to execute the code to cause the UE to:
select the first carrier in accordance with the prediction based at least in part on a quantity of channel datasets satisfying a first threshold, a quantity of failed RACH attempts satisfying a second threshold, a duration satisfying a third threshold, or any combination thereof.

7. The UE of claim 1, wherein:
for the first RACH attempt, a second carrier of the plurality of different carriers is associated with a higher RSRP than the first carrier, and
the first carrier is selected for the first RACH attempt based at least in part on the prediction associated with the first carrier and the second carrier being associated with the higher RSRP than the first carrier.

8. The UE of claim 1, wherein the plurality of parameters comprise a downlink reference signal reserve power associated with the first carrier, a signal-to-noise ratio, a pathloss, a RACH configuration, a quantity of RACH attempts associated with the RACH procedure, location coordinates, a selected synchronization signal block, a purpose associated with the RACH procedure, a physical RACH (PRACH) transmit power, an uplink block error rate (BLER), a downlink BLER, a transmission power of the UE, a maximum transmit power level (MTPL), or any combination thereof.

9. The UE of claim 1, wherein the first carrier is a supplementary uplink and a second carrier of the plurality of different carriers is a normal uplink.

10. A method for wireless communications at a user equipment (UE), comprising:
receiving configuration information indicating for the UE to evaluate a plurality of parameters at each random access channel (RACH) attempt;
monitoring one or more carriers of a plurality of different carriers, based at least in part on the configuration information, to obtain a channel dataset comprising values for the plurality of parameters associated with a first RACH attempt;
selecting a first carrier from the plurality of different carriers in accordance with a prediction associated with the first carrier based at least in part on the channel dataset, wherein the prediction indicates a likelihood of successfully performing a RACH procedure using the first carrier; and
communicating one or more messages of a RACH procedure using the first carrier.

11. The method of claim 10, wherein selecting the first carrier further comprises:
selecting the first carrier based at least in part on a quantity of failed RACH attempts associated with a second carrier of the plurality of different carriers satisfying a threshold.

12. The method of claim 10, further comprising:
declaring a radio link failure, terminating the RACH procedure, or both, based at least in part on a quantity of failed RACH attempts associated with a first carrier satisfying a first threshold and a second quantity of RACH attempts associated with a second carrier satisfying a second threshold.

13. The method of claim 10, further comprising:
declaring a radio link failure, terminating the RACH procedure, or both, based at least in part on a quantity of failed RACH attempts for the first carrier satisfying an early termination threshold.

14. The method of claim 10, further comprising:
monitoring the one or more carriers of the plurality of different carriers, based at least in part on the configuration information, to obtain an updated channel dataset comprising updated values for the plurality of parameters associated with a second RACH attempt that occurs subsequent to the first RACH attempt;
selecting the first carrier or a second carrier from the plurality of different carriers in accordance with a second prediction associated with the first carrier or the second carrier based at least in part on the updated channel dataset, wherein the second prediction indicates a likelihood of successfully performing a RACH procedure using the first carrier or the second carrier; and
communicating one or more messages of a second RACH procedure using the first carrier or the second carrier.

15. The method of claim 10, wherein selecting the first carrier further comprises:
selecting the first carrier in accordance with the prediction based at least in part on a quantity of channel datasets satisfying a first threshold, a quantity of failed RACH attempts satisfying a second threshold, a duration satisfying a third threshold, or any combination thereof.

16. The method of claim 10,
wherein, for the first RACH attempt, a second carrier of the plurality of different carriers is associated with a higher RSRP than the first carrier, and
wherein the first carrier is selected for the first RACH attempt based at least in part on the prediction associated with the first carrier and the second carrier being associated with the higher RSRP than the first carrier.

17. The method of claim 10, wherein the plurality of parameters comprise a downlink reference signal reserve power associated with the first carrier, a signal-to-noise ratio, a pathloss, a RACH configuration, a quantity of RACH attempts associated with the RACH procedure, location coordinates, a selected synchronization signal block, a purpose associated with the RACH procedure, a physical RACH (PRACH) transmit power, an uplink block error rate (BLER), a downlink BLER, a transmission power of the UE, a maximum transmit power level (MTPL), or any combination thereof.

18. The method of claim 10, wherein the first carrier is a supplementary uplink and a second carrier of the plurality of different carriers is a normal uplink.

19. A non-transitory computer-readable medium storing code for wireless communications, the code comprising instructions executable by one or more processors to:
receive configuration information indicating to evaluate a plurality of parameters at each random access channel (RACH) attempt;
monitor one or more carriers of a plurality of different carriers, based at least in part on the configuration information, to obtain a channel dataset comprising values for the plurality of parameters associated with a first RACH attempt;
select a first carrier from the plurality of different carriers in accordance with a prediction associated with the first carrier based at least in part on the channel dataset, wherein the prediction indicates a likelihood of successfully performing a RACH procedure using the first carrier; and
communicate one or more messages of a RACH procedure using the first carrier.

20. The non-transitory computer-readable medium of claim 19, wherein the instructions are further executable by the one or more processors to:
monitor the one or more carriers of the plurality of different carriers, based at least in part on the configuration information, to obtain an updated channel dataset comprising updated values for the plurality of parameters associated with a second RACH attempt that occurs subsequent to the first RACH attempt;
select the first carrier or a second carrier from the plurality of different carriers in accordance with a second prediction associated with the first carrier or the second carrier based at least in part on the updated channel dataset, wherein the second prediction indicates a likelihood of successfully performing a RACH procedure using the first carrier or the second carrier; and
communicate one or more messages of a second RACH procedure using the first carrier or the second carrier.
